(19) United States
(12) Patent Application Publication
(10) Pub. No.: US 2019/0314781 A1
(43) Pub. Date: Oct. 17, 2019

(54) NAPHTHA CATALYTIC CRACKING METHOD WITH COMPARTMENTS IN THE TURBULENT FLUIDISED BED REACTOR

(71) Applicant: IFP Energies Nouvelles, Rueil-Malmaison Cedex (FR)

(72) Inventors: Ann CLOUPET, Longes (FR); Ludovic RAYNAL, Oullins (FR)

(73) Assignee: IFP Energies Nouvelles, Rueil-Malmaison Cedex (FR)

(21) Appl. No.: 16/469,750

(22) PCT Filed: Dec. 8, 2017
(86) PCT No.: PCT/EP2017/082087

§ 371 Date: Jun. 14, 2019

(30) Foreign Application Priority Data
Dec. 15, 2016 (FR) 1662537

(51) Int. Cl. B01J 8/18; C10G 11/18; C10G 51/06; B01J 8/26

(52) U.S. Cl. CPC B01J 8/1872; C10G 11/18; C10G 51/06; B01J 8/26; B01J 2208/00654; C10G 2400/20; C10G 2400/22; B01J 2208/00884; C10G 2300/1085

(57) ABSTRACT

The present invention describes a turbulent fluidized bed reactor having a diameter of between 6 and 25 meters and an H/D ratio of between 0.1 and 1, and exhibiting a compartmentation with a central zone, this reactor been particularly well suited to the catalytic cracking of light cuts for the purpose of producing major intermediates of petrochemistry and in particular light olefins.

### CONTEXT OF THE INVENTION

The NCC (abbreviation of Naphtha Catalytic Cracking) process can be defined as a development of the catalytic cracking (FCC) process, the distinguishing feature of which is to crack light paraffinic feedstocks of gasoline type, that is to say having from 5 to 12 carbon atoms, in order to produce in particular light olefins and aromatics.

The cracking of these light cuts to give desired products (propylene, ethylene, BTX, and the like) requires a contact time of the order of a second and the catalyst has to be frequently regenerated. The most appropriate reactor for meeting these criteria is a circulating turbulent fluidized bed reactor. In order to achieve high production capacities, the diameter of the industrial reactor can reach 10 m and more, the height remaining relatively low in order to satisfy the criterion of the contact time desired, which, in the context of the NCC process, is of the order of a few seconds, resulting in reactors with a low height to diameter (H/D) ratio, generally of less than 0.5.

The invention describes a reactor suitable for the implementation of the cracking of light paraffinic cuts, said reactor being compartmentalized, making it possible to achieve diameters of 10 m and more, and exhibiting a low H/D ratio, that is to say of less than 0.5.

Such a reactor makes it possible ultimately:
to limit the risks of the extrapolation to a large scale,
to provide good mixing between the gas and the solid, and thus to guarantee good performance qualities of the reactor,
to make possible a flexibility of operation over the different zones,
indeed even, in an alternative configuration, with circulation of the catalyst between compartments, to improve the performance qualities of the process.

The present invention comprises not only the compartmentalized fluidized reactor but also the central stripping chamber, which is itself fluidized. The reactor/stripper assembly forms a whole.

### DESCRIPTION OF THE FIGURES

FIG. 1 represents a sectional view of the reaction zone (reactor+stripper) in the case of the compartments in parallel. Four compartments have been represented by way of example, without this being limiting.

FIG. 2 represents a top view of the reaction zone and makes it possible to clearly display the different compartments.

FIG. 3 is a 3D view of the reactor according to the invention in the configuration of compartments operating in parallel which makes it possible to better observe the direction of flow from the compartments toward the central stripping chamber.

FIG. 4 is a 3D view of the reaction zone (reactor+stripper) in the case of the compartments operating in series. The heights of the partitions 4a, 4b, 4c and 4d are decreasing, so as to make possible natural overflowing from one compartment to the next. The transfer toward the central stripping chamber takes place starting from the final compartment of the series.

FIG. 5 represents the equivalent diameter of each compartment.

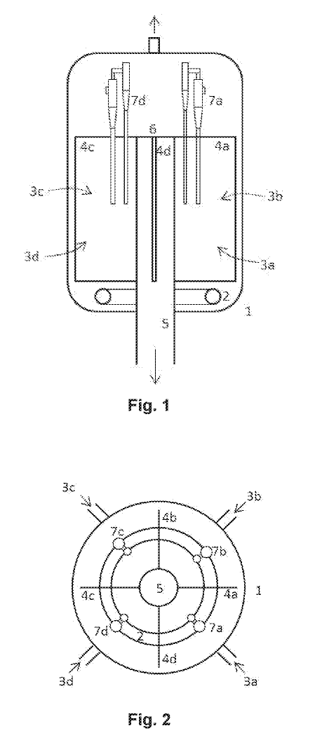

More specifically, FIG. 1 is a sectional view of the reactor and of the stripper according to the invention in which 2 compartments a and d, and the central chamber 5 representing the stripper, and also the cyclones 7a and 7d, which make possible gas/solid separation before reintroduction of the catalytic solid into the compartment or compartments concerned, can be seen. The reactor is fluidized using a gas distributor 2 of ring or sparger type, the gas being a mixture of the vaporized feedstock and of steam.

FIG. 2 is a top view of the reactor-stripper according to the invention which makes it possible to clearly display the radial walls 4a, 4b, 4c and 4d delimiting the different compartments a, b, c and d, and also the central chamber (5). The fluidization ring is, in this figure, shared by the different compartments. It is also possible to envisage independent distributors, feeding the different compartments.

Each compartment is fed with regenerated catalyst via a pipe which is specific to it (3a, 3b, 3c and 3d), the catalyst flow rate being regulated for each compartment. It is in this respect that this configuration is known as “in parallel”. The catalyst of each compartment overflows at the top (6) of the central chamber (5), in order to be stripped and then directed to the regenerator (not represented in the figures).

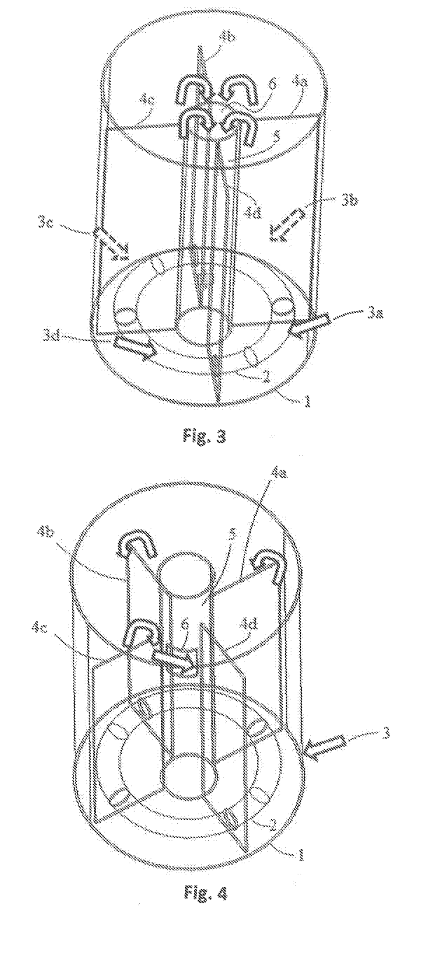

FIG. 3 represents a 3D view of the preceding FIGS. 1 and 2.

FIG. 4 represents the reaction zone in a configuration of compartments “in series”. It differs from the “in parallel” configuration in two main points:
a single catalyst feed (3) feeds the reactor at the first compartment a,
the catalyst passes from one compartment to another by overflowing, using walls of different heights. At the final compartment d, the catalyst enters the stripper via the window (6).

In the two configurations (in parallel and in series), the number of compartments can vary between 2 and 12 and preferably between 3 and 9.

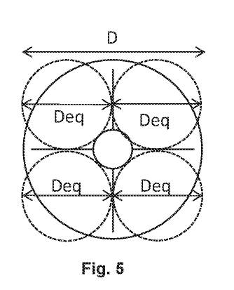

FIG. 5 represents the equivalent diameter Deq of each compartment: the surface area of a compartment corresponds to the surface area of a disk of diameter Deq.

### EXAMINATION OF THE PRIOR ART

The prior art in the field of compartmentalized fluidized beds is fairly rich, even remaining within the context of refining and petrochemistry. A few significant documents are shown below:

The thesis of P. Pongsivapai, entitled “Residence Time Distribution of Solids in a Multi-Compartment Fluidized Bed System” (Oregon State University, 1994), discusses the use of a compartmentalized fluidized bed in order to render uniform the residence time of the solid. The purpose of this study is to get closer to plug flow by connecting several fluidized beds in series, in order to increase the conversion of the solid.

The driving force which makes it possible to cause the solid to pass from the 1st to the 2nd compartment is generated by the difference in pressure through the orifice between the two compartments.

The patent EP 0 607 363 describes a series of rectangular fluidized bed zones for the process for the continuous coating of particles of fertilizer substrate, with different gas velocities according to the zones.

A pipe having an upper opening in a portion of the 1st fluidized bed and a lower opening in a lower portion of the 2nd fluidized bed makes it possible to cause the particles to circulate from the 1st to the 2nd bed by varying the velocity gradient of the gas.

The U.S. Pat. No. 3,236,607 describes a reactor for the reduction of iron ore exhibiting several stages, in order to control the degree of conversion at each stage. The use of transverse walls in the reactor makes it possible to reduce the back mixing of the solid, thus promoting the conversion. The passage of the solid from one compartment to another takes place by overflowing. This configuration makes possible the use of different gases in the different zones.

The patent KR 100 360 110 describes a fluidized bed reactor which makes it possible to achieve a high efficiency and to reduce the back mixing phenomenon. The reactor described in this document comprises three fluidized chambers separated by vertical partitions and in communication with one another via orifices in the immersed position.

The present invention describes a fluidized reactor having a low height/diameter ratio (H/D of less than 0.5) with a diameter D of greater than 6 meters, which can reach 25 meters, this reactor exhibiting different compartments which can operate in series or in parallel.

The reactor according to the invention also has a central chamber which is in communication with the one or the different compartments and which makes it possible to strip the catalyst, before being sent to the regenerator.

In the prior art, compartmentalized fluidized reactors, the compartments of which were delimited by orifice-free radial partitions, have not been found and none of the reactors examined exhibits a diameter in the range from 10 to 25 meters.

### BRIEF DESCRIPTION OF THE INVENTION

The present invention can be defined as a compartmentalized fluidized bed reactor for the catalytic cracking of light cuts for the purpose of producing light olefins, said reactor having a diameter of between 6 and 25 meters, preferably of between 10 and 20 meters, and an H/D ratio of between 0.1 and 1, and preferably of between 0.2 and 0.6.

This reactor thus has a relatively flat shape and exhibits compartments obtained by vertical radial partitions extending substantially over the entire height H of the reactor.

These compartments thus have the form of radial sectors, generally identical to one another, although it remains within the context of the invention to have compartments which are different in size.

The reactor according to the invention is provided with a cylindrical chamber located substantially at the center of the reactor, which chamber will be referred to subsequently as central chamber, which communicates by overflowing with said compartments in the “in parallel” case or with the final compartment in the “in series” case.

This chamber, which is itself fluidized, has the role of providing the stripping of the catalyst, that is to say of desorbing the hydrocarbons adsorbed at the surface of the catalyst before sending the latter to the regeneration zone. The regeneration zone will not be described in the present invention as it does not exhibit a specific difference with regard to the regeneration zone of a conventional catalytic cracking unit.

The ratio of the diameter of the central chamber to the diameter of the reactor is generally between 0.1 and 0.5 and preferably between 0.15 and 0.3. The diameter of the stripper is dimensioned so that the catalyst stream is between 20 and 250 kg/m²/s.

The upper part of the reactor located above the compartments makes possible the separation of the fluidization gas and of the catalytic solid particles, the latter being reintroduced into the fluidized compartments. The gaseous effluents and the catalyst particles are generally separated by one or more stages of cyclones, the return legs of which are immersed in the fluidized bed of each compartment, or only in some compartments.

Generally, the compartmentalized fluidized bed reactor-stripper according to the invention has a number of radial compartments substantially of between 2 and 12, preferably of between 3 and 9. This compartmentation makes it possible to pass from a reactor with one H/D ratio to several compartmentalized reactors of ratio H/Deq.

In the case of n compartments with the same section, Deq is equal to D divided by the square root of n. In the case of 4 equal compartments, the height to diameter ratio of a compartment is thus equal to twice that of the reactor without compartmentation.

According to a preferred alternative form, the compartmentalized fluidized bed reactor according to the invention is fluidized either by a gas distributor shared by all of the compartments, for example a single ring which serves every compartment, or by an individual fluidization device at each compartment, it being possible for this device to commonly be a ring or a sparger.

The term “sparger” refers to any fluidization gas distribution system which exists in the form of a grid provided with branchings. These fluidization devices, ring or sparger, are well known to a person skilled in the art and will not be described further.

In a preferred alternative form, the reactor is fluidized by a single ring serving every one of the compartments and covering the whole of the reactor.

The main application of the reactor-stripper according to the invention is the process for the catalytic cracking of light paraffinic cuts for the purpose of producing major intermediates of petrochemistry and in particular ethylene, propylene and BTX, which process is known as NCC by abbreviation of “Naphtha Catalytic Cracking”.

This process differs from the catalytic cracking of heavy cuts, of VGO or vacuum distillates type, commonly known as FCC (Fluidized Catalytic Cracking), in the need for a higher contact time between the catalyst and the feedstock. A few fractions of a second for FCC changes to a few seconds for NCC.

Another characteristic differentiating FCC and NCC is the thermal balance of the unit. For FCC, and for most of the cuts treated, the thermal balance is naturally balanced, that is to say that the heat generated by the combustion of the coke deposited on the catalyst is sufficient to maintain the different posts of consumption of heat, the evaporation of the feedstock and the endothermicity of the cracking reactions.

In NCC, as the formation of coke is markedly lower due to the low Conradson carbon of the feedstocks, it is necessary to introduce an extra cut of the feedstock in order to contribute the necessary heat. This lower formation of coke also explains the possibility of a greater residence time of the solid in the NCC reactor than in that of the FCC riser. This aspect will not be developed further but the operation in series of the reactor, insofar as it makes it possible to adjust the feedstock flow rate in each compartment, can thus make it possible to change this feedstock flow rate as a function of the mean coke content of the catalyst present in each compartment, which content increases from one compartment to the next.

In an alternative form of the application of the reactor according to the invention to NCC, the compartments of the reactor operate in parallel at a fluidization velocity of between 0.5 and 1.5 m/s, preferably between 0.7 and 1.3 m/s and more preferably between 0.8 and 1 m/s.

In another alternative form of the application of the reactor according to the invention to NCC, the compartments operate in series, the passage from one compartment to the next taking place by overflowing, and it being possible for the fluidization velocity, on passing from one compartment to the next, to decrease by approximately 15%, preferably by 10%.

The function of stripping the catalyst carried out by the central chamber makes it possible to remove the hydrocarbons adsorbed on the catalyst and operates in a fluidized bed at a fluidization velocity of between 0.1 and 0.5 m/s and preferably between 0.2 and 0.4 m/s. The catalyst stream in the stripper is between 20 and 250 kg/m²/s.

### DETAILED DESCRIPTION OF THE INVENTION

The present invention describes a compartmentalized fluidized reactor, with a diameter of greater than 6 meters, which can range up to 25 meters, and with a low H/D ratio (<0.5), in order:
to limit the risks of the extrapolation to a large scale,
to provide good mixing between the gas and the solid,
to make possible a flexibility of operation over the different zones (gas velocity, feedstock to vapor ratio, denoted H/C),
indeed even, in an alternative configuration, with circulation of the catalyst between compartments, to improve the performance qualities of the process.

Generally, it is known from the prior art that, in a fluidized bed reactor, the fluidization gas injected at the bed bottom entrains the solid mainly at the center of the reactor in an upward stream, the latter redescending at the wall, thus creating a solid recirculation cell.

In the case of large diameters, and for low H/D ratios, several solid recirculation cells are formed in parallel (this phenomenon is described in particular in the reference work: “Handbook of fluidization and fluid-particle systems”, 2003).

For one and the same superficial gas velocity, by increasing the diameter of the reactor, and consequently the number of recirculation cells, the magnitude of the mixing of the solid substantially decreases, which might be prejudicial to the performance qualities of the reactor.

To our knowledge, industrial fluidized bed reactors, dedicated to FCC regenerators, for example, reach a maximum of 15 m in diameter. Furthermore, in the case of the regeneration of the FCC coked catalyst, it is a matter of injecting air—which is injected in excess—in order to incinerate the coke.

In the present invention, it is a matter of converting a gaseous hydrocarbon feedstock to the highest degree.

The contact between the gas and the solid is thus essential in the case of the invention, both at the reaction zone itself and at the stripper, the purpose of which is to remove to the highest possible degree the fraction of gaseous effluents which is entrained with the catalyst stream and also that adsorbed at the surface of the catalyst particles.

The invention describes a compartmentalized fluidized reactor with a large diameter (from 6 m to 25 m) and with a low H/D ratio (<0.5).

Radial walls define several compartments in the reactor, each compartment representing an angular sector of the reactor. The compartments may or may not be identical in size. The multiplication of these compartments makes it possible to maintain a high degree of mixing of the solid in each compartment.

The reactor according to the invention is thus well suited to carrying out catalytic cracking reactions on light, olefinic and/or paraffinic, feedstocks in the range of the carbon numbers extending from 5 to 12, for the purpose of producing major intermediates of petrochemistry, and in particular light olefins, mainly propylene and ethylene (but also hydrogen, butenes and a gasoline cut containing in high proportion olefinic and aromatic hydrocarbons).

In this type of cracking, the catalyst has to be regenerated in a unit carrying out the combustion of the adsorbed coke which was formed during the reaction phase, as in any catalytic cracking unit, even if, given the range of the feedstocks concerned, the potential for formation of coke of which is low, the formation of coke is markedly lower than in an FCC unit operating on a conventional feedstock of vacuum distillate or atmospheric residue type.

The catalyst, before being regenerated, is subjected to a stripping stage in order to desorb the hydrocarbons adsorbed at the surface of the catalyst.

According to the present invention, the stripping chamber forms an integral part of the reactor and is located at the center in the form of a central cylindrical chamber.

This central cylindrical chamber is generally provided with a packing or with any other element which promotes contacting between the gas phase and the dispersed solid phase.

The radial walls of the reaction compartments are attached (generally by welding but any other means known to a person skilled in the art comes within the context of the present invention) to the chamber of the stripper in order not to be subject to thermal expansions.

According to a first alternative form of the present invention, the different compartments of the reactor operate in parallel.

In the configuration of the compartments in parallel, the fresh catalyst originating from the regenerator feeds each reaction compartment via a pipe, each pipe being provided with a valve which makes it possible to regulate the catalyst flow rate (as represented in FIGS. 1, 2 and 3).

In the case of the compartments operating in series (as represented in FIG. 4), a single compartment is fed with regenerated catalyst, the others being fed by overflowing from the preceding compartment toward the following.

In both cases, series or parallel, after stripping, the catalyst is directed toward the regenerator.

The residence time of the catalyst is the same in both configurations:
in the case of the compartments in parallel, it is equal to the volume of the reactor Vr divided by the number of compartments, divided by the flow rate for circulation of the catalyst Cv divided by the number of compartments, i.e. Vr/Cv. The number of compartments no longer appears in the expression of the residence time.
in the case of the compartments in series, it is equal to the volume of the reactor Vr divided by the number of compartments, divided by the flow rate for circulation of the catalyst, multiplied by the number of compartments, i.e. Vr/Cv. The number of compartments thus no longer appears.

The difference between the series operating mode and the parallel operating mode lies in the fact that, in the case of the compartments in series, the catalyst is increasingly coked on advancing from one compartment to another. It is thus more advantageous to distribute the feedstock flow rate regressively in the different compartments. Regressive distribution is understood to mean a decrease in the feedstock flow rate as a function of the content of coke of the catalyst, which content increases on advancing from one compartment to the next.

The vaporized feedstock, in general with steam, is injected via a gas distributor at the reactor bottom, in order to fluidize the different compartments and to convert the feedstock in contact with the catalyst.

In general, the introduction of the catalyst is located substantially above the feedstock injectors of a given compartment, so as to prevent any formation of a fixed bed under the level of injection of the feedstock.

If the reaction compartments operate in parallel, each compartment makes possible overflowing toward the central stripping chamber by increase in the level of the bed in each compartment.

If the reaction compartments operate in series, then the overflowing toward the stripping chamber is carried out from the final compartment of the series.

In the case of compartments operating in series, it is possible to render the fluidization velocity of each of them different, so as to cause the contact time to vary. This possibility is highly advantageous in compensating, by an increase in the residence time, for the fall in temperature of the catalyst from one compartment to the next due to the cracking reactions, which are endothermic overall.

Thus, each reaction compartment operates with a temperature-residence time-gas/solid contact time triplet which makes possible the maintenance of a certain reaction effectiveness.

The catalyst can be any type of catalyst, preferably containing a high proportion of zeolite Y and/or of zeolite ZSM-5. It can even be 100% composed of zeolite ZSM-5.

### Example According to the Invention

The present example provides the dimensioning of a reactor-stripper according to the invention which makes it possible to treat a straight run gasoline feedstock having a distillation range of between 30 and 100° C., for the purpose of producing, as a priority, propylene.

The feedstock ranging from C5 to C9 is a paraffinic feedstock having the composition given in table 1 below:

TABLE 1
composition of the feedstock

| | P | IP | O | N | A |
|---|---|---|---|---|---|
| C5 | 2.31 | 0.39 | 0.00 | 0.00 | 0.00 |
| C6 | 23.24 | 21.20 | 0.00 | 10.74 | 2.54 |
| C7 | 8.12 | 19.19 | 0.00 | 7.80 | 1.54 |
| C8 | 0.00 | 0.46 | 0.00 | 0.61 | 0.01 |
| C9 | 0.00 | 0.02 | 0.00 | 0.03 | 0.00 |
| Total | 33.67 | 41.26 | 0.00 | 19.18 | 4.09 |

P means paraffins, IP means isoparaffins or branched paraffins, 0 means olefins, N means naphthenes and A means aromatics. In the example of table 1, the feedstock does not contain olefins but, in some cases, it is entirely possible for it to contain them, up to a content of 40%.

Table 2 below gives the ethylene, propylene and BTX yields obtained at 610° C., for contact times of 100 ms, 600 ms, 1600 ms and 4000 ms, following an experiment on a small pilot plant.

TABLE 2
change in the yields as a function of the contact time

| | Ethylene yield | Propylene yield | BTX yield |
|---|---|---|---|
| | (% wt) | (% wt) | (% wt) |
| t_{c} = 100 ms | 7 | 14 | 4.5 |
| t_{c} = 600 ms | 8.5 | 17 | 7 |
| t_{c} = 1600 ms | 15 | 19 | 11 |
| t_{c} = 4000 ms | 20 | 17.5 | 15 |

The existence is observed, in the light of table 2, of an optimum contact time for the production of propylene in the vicinity of the value of 1600 ms since, after having increased this contact time between 100 ms and 1600 ms, the propylene yield decreases significantly for a contact time of 4000 ms.

The ethylene and BTX yields continue to increase at least up to 4000 ms.

In order to promote the yields of desired products, a contact time of a few seconds is thus necessary. From the perspective of maximizing the selectivity for propylene, the optimum contact time chosen in this example is 1.6 seconds.

The other operating conditions are as follows:

Feedstock flow rate: 63000 barrels/day

Contact time: 1.6 seconds

Temperature: 610° C.

Total pressure: 1.2 bars

HC partial pressure: 0.6 bar

The contact time of 1.6 seconds is obtained in a dimensioned compartmentalized turbulent fluidized bed reactor in the following way:

The feedstock is injected with steam (20% by weight of steam with respect to the feedstock).

Diameter of the reactor D: 15 meters

Height of the reactor H: 4 meters

Diameter of the central stripper: 3 meters

The H/D (height to diameter) ratio of the reactor is 0.27.

Number of compartments working in parallel: 4 (H/Deq of each compartment is thus equal to 0.53)

Fluidization velocity in each compartment: 50 cm/s at the bottom, i.e. 1.2 m/s at the top (taking into account the molar expansion related to the production of lighter molecules than those of the feedstock)

Fluidization velocity in the central stripper: 20 cm/s (solid flow of 50 kg/m²/s)

In the case of operation in series, the dimensions of the reactor are the same as presented above. On the other hand, the fluidization velocities in the different compartments are different.

A decrease in the feedstock flow rate is practiced from one compartment to the next, according to the staging below. This is in order to take into account the increase in the coke content during the progression of the cracking reaction.

Fluidization velocity in compartment 1: 1.2 m/s at the top

Fluidization velocity in compartment 2: 1.1 m/s at the top

Fluidization velocity in compartment 3: 1.0 m/s at the top

Fluidization velocity in compartment 4: 0.9 m/s at the top.

1) A compartmentalized fluidized bed reactor for the catalytic cracking of light cuts for the purpose of producing major intermediates of petrochemistry and in particular light olefins, said reactor having a diameter of between 6 and 25 meters, preferably of between 10 and 20 meters, and an H/D ratio of between 0.1 and 1, and preferably of between 0.2 and 0.6, and exhibiting compartments obtained by vertical radial partitions extending substantially over the entire height H of the reactor, and being provided with a central cylindrical chamber which communicates by overflowing with a or the said compartments, the ratio of the diameter of the central chamber to the diameter of the reactor being between 0.1 and 0.5 and preferably between 0.15 and 0.3, the upper part of the reactor located above the compartments making possible the separation of the fluidization gas and of the catalytic solid particles, and the compartments of said reactor being fluidized at a fluidization velocity of between 0.5 and 1.5 m/s, preferably between 0.7 and 1.3 m/s and more preferably between 0.8 and 1 m/s.

2) The compartmentalized fluidized bed reactor as claimed in claim 1, in which the number of substantially identical radial compartments is between 2 and 12, preferably between 3 and 9, so that the height to equivalent diameter (H/Deq) ratio of each compartment is greater than 0.5.

3) The compartmentalized fluidized bed reactor as claimed in claim 1, in which all of the compartments are fluidized by means of a single ring which covers the whole of the reactor.

4) A process for the catalytic cracking of light paraffinic cuts using the reactor as claimed in claim 1, in which the compartments of the reactor operate in parallel.

5) A process for the catalytic cracking of light paraffinic cuts using the reactor as claimed in claim 1, in which the compartments operate in series, the passage from one compartment to the next taking place by overflowing.

6) A process for the catalytic cracking of light paraffinic cuts using the reactor as claimed in claim 1, in which the central chamber is used as stripper in order to remove the hydrocarbons adsorbed on the catalyst and operates as a fluidized bed at a fluidization velocity of between 0.1 and 0.5 m/s and preferably between 0.2 and
0.4 m/s.
